(19) United States
(12) Patent Application Publication
(10) Pub. No.: US 2015/0195001 A1
(43) Pub. Date: Jul. 9, 2015

(54) ANTENNA SYSTEM WITH ENHANCED INTER-SECTOR INTERFERENCE MITIGATION

(71) Applicant: Quintel Technology Limited, Bristol (GB)

(72) Inventors: DAVID EDWIN BARKER, Stockport (GB); Lance Darren Bamford, Pittsford, NY (US); Peter Chun Teck Song, San Francisco, CA (US); Brent Irvine, Rochester, NY (US)

(21) Appl. No.: 14/590,729

(22) Filed: Jan. 6, 2015

Related U.S. Application Data
(60) Provisional application No. 61/924,567, filed on Jan. 7, 2014.

(51) Int. Cl. H04B 1/54; H04B 1/40

(52) U.S. Cl. CPC H04B 1/54; H04B 1/40

(57) ABSTRACT

In one example, an antenna system includes a radio base station for transmitting an RF signal via a transmission port, an RF splitting means for receiving the RF signal from the radio base station and for splitting the RF signal into two component signals, and at least two antennas separated by a distance greater than one wavelength and connected to the RF splitting means for transmitting the respective component signals such that an inferometric radiation gain pattern is created. The radio base station communicates with at least one mobile terminal via a dispersive multi-path radio channel where an angular spread of RF energy between the at least two antennas and the at least one mobile terminal causes nulls of the inferometric radiation pattern across a range of angles to be reduced.

### CROSS REFERENCE TO RELATED APPLICATIONS

This application claims priority to U.S. Provisional Patent Application Ser. No. 61/924,567, filed Jan. 7, 2014, which is herein incorporated by reference in its entirety.

### FIELD OF THE DISCLOSURE

The present disclosure relates generally to antenna systems, and more specifically to base station antenna systems that control azimuth radiation pattern roll-off rate when deployed at a sectored base station site.

### BACKGROUND

Cellular base station sites are typically designed and deployed with three sectors arranged to serve different azimuth bearings, for example each sector serving a 120 degree range of angle from a cell site location. Each sector consists of an antenna with an azimuthal radiation pattern which defines the sector coverage footprint. The azimuth radiation pattern of a base station sector antenna is generally optimal at around 65 degrees (+/−3 dB beamwidth) as this provides sufficient gain and efficient tri-sector site tessellation of multiple sites in a network or cluster of sites serving a cellular network area.

Most mobile data cellular network access technologies including High Speed Packet Access (HSPA) and Long Term Evolution (LTE) employ 1:1 or full spectrum re-use schemes in order to maximise spectral efficiency and capacity. This aggressive spectral re-use means that inter-sector and inter-cell interference needs to be minimised so that spectral efficiency can be maximised. Antenna tilting, normally delivered by electrical phased array beam tilt provides a network optimisation freedom to address inter-cell interference, but few options exist to optimise inter-sector interference. The Front-to-Back (FTB), Front-to-Side (FTS) and Sector Power Ratio (SPR) of an antenna pattern are parameters which indicate the amount of inter-sector interference; the larger the FTB and FTS and the lower the SPR value, the lower the inter-sector interference. A better metric to understand inter-sector interference and hence potential throughput performance might be to calculate the resulting Signal to Interference (C/I) ratio as a function of azimuth angle, where it is desirable to achieve high C/I Ratios for as wide an aperture as possible.

Reducing the 3 dB azimuth beamwidth to 60 degrees or even 55 degrees will typically improve the SPR, but may also impact cellular network tessellation efficiency for basic service coverage, and necessarily requires a wider antenna to achieve the narrower beamwidth which then places additional pressure on the site in terms of zoning, wind-loading and rentals. Base station antennas with variable azimuth beamwidth for instance are available which can be used to provide better load balancing between sectors and to adjust sector to sector overlap. However, such solutions may not be suitable for accommodating multiple arrays and hence supporting multiple spectrum bands which is a desirable requirement for base station antennas. Such variable beamwidth antennas can be large (the size being governed by the minimum achievable beamwidth) with some solutions requiring mechanical and active electronics and hence potentially costly to deploy and maintain.

### SUMMARY

In one example, the present disclosure describes an antenna system having at least one radio base station for transmitting at least one RF signal via at least one transmission port, at least one RF splitting means for receiving the at least one RF signal from the at least one radio base station and for splitting the at least one RF signal into two component signals, and at least two antennas separated by a distance greater than one wavelength and connected to the at least one RF splitting means for transmitting the respective component signals such that an inferometric radiation gain pattern is created. The at least one radio base station communicates with at least one mobile terminal via a dispersive multi-path radio channel where an angular spread of RF energy between the at least two antennas and the at least one mobile terminal causes nulls of the inferometric radiation pattern across a range of angles to be reduced.

### BRIEF DESCRIPTION OF THE DRAWINGS

The teaching of the present disclosure can be readily understood by considering the following detailed description in conjunction with the accompanying drawings, in which:

FIGS. 1A-1C illustrate examples of the present disclosure utilizing the angular dispersion of the mobile radio channel which null-fills an intentionally created inferometric radiation pattern and maintains strong nulls broadside to the antenna arrangement; in particular, FIG. 1A illustrates an azimuth radiation gain pattern with no multi-path, FIG. 1B illustrates an azimuth radiation gain pattern example according to the present disclosure and a dispersive radio channel, and FIG. 1C illustrates a resulting effective azimuth radiation gain pattern when in a dispersive radio channel;

FIG. 2 illustrates a first example of the present disclosure showing a 2T2R radio (a dual-duplexed radio unit with two transmit/receive (Tx/Rx) duplexed ports) connected via RF splitters to two spatially separated dual-polarised base station antennas to create an optimized inferometric radiation pattern in azimuth;

FIGS. 3A-3C illustrate how the example of FIG. 2 utilizes the angular dispersion of the mobile radio channel which null-fills an intentionally created inferometric radiation pattern and maintains strong nulls broadside to the antenna arrangement; in particular, FIG. 3A illustrates an azimuth radiation gain pattern without multi-path, FIG. 3B illustrates an azimuth radiation gain pattern in a dispersive radio channel and FIG. 3C illustrates a resulting C/I ratio as a function of azimuth angle when the example of FIG. 2 is deployed on three sectors of a tri-sector base station site;

FIG. 4 illustrates a second example of the present disclosure including a 2T4R radio (a radio unit with two Tx/Rx duplexed ports and two Rx only ports) connected via RF hybrid couplers to two spatially separated dual-polarised base station antennas to create an optimized inferometric transmit (Tx) radiation pattern in azimuth;

FIG. 5 illustrates a third example of the present disclosure including two 2T2R radios operating in proximate spectrum bands connected via RF hybrid couplers to two spatially separated dual-polarised base station antennas to create optimized inferometric Tx radiation patterns in azimuth;

FIG. 6 illustrates a fourth example of the present disclosure including a 2T2R radio connected via RF splitters to three spatially separated dual-polarised base station antennas to create an optimized inferometric radiation pattern in azimuth; and

FIGS. 7A-7B illustrate how the example of FIG. 6 utilizes the angular dispersion of the mobile radio channel which null-fills an intentionally created inferometric radiation pattern and maintains strong nulls broadside to the antenna arrangement; in particular, FIG. 7A illustrates an azimuth radiation gain pattern in a dispersive radio channel and FIG. 7B illustrates a resulting C/I ratio as a function of azimuth angle when the example of FIG. 6 is deployed on three sectors of a tri-sector base station site.

To facilitate understanding, identical reference numerals have been used, where possible, to designate identical elements that are common to the figures.

### DETAILED DESCRIPTION

The present disclosure describes a base station antenna solution that controls azimuth radiation pattern roll-off rate and in particular Front-to-Side Ratio (FSR) when deployed at a sectored base station site. In one example, the present disclosure includes the use of two identical conventional directional dual-polarised base station sector antennas which face in the same direction, or azimuth bearing, and which are disposed horizontally nominally at an odd number of half wavelengths apart, where co-polar ports of the antennas are co-phased together for connection to a base station. The resulting radiation pattern is one which is inferometric, i.e., having a number of grating lobes and nulls, but in particular creating wide angular radiation pattern nulls broadside to the antennas, i.e., at approximately +/−90 degrees relative to boresight in the horizontal plane of the antennas, which serve to reduce FSR, and hence reduce inter-sector co-channel interference when the antenna arrangement is deployed on all sectors of a tri-sector base station cellular site for instance. In addition, multi-path dispersion of the mobile radio channel is exploited such that the angular spread of the radio channel causes the inferometric azimuth radiation pattern created across the desired+/−60 degrees sector service area to be null-filled by radio channel scattering and dispersion. In other words, nulls of the inferometric radiation pattern are reduced across a range of angles as compared to the same communication scheme without radio channel dispersion and scattering. The antenna solution is generally optimised for minimum inter-sector interference when the antenna separation distance is such that the azimuthal angular spread of the radio channel is greater than the angular width of the inferometric nulls in the desired direction, but where the angular spread less than the width of the angular nulls created at approximately +/−90 degrees bearings.

The present disclosure provides an antenna deployment and design solution suitable for cellular base stations which can provide enhanced inter-sector interference, or adjustable sector overlap for optimising a cellular network design. Examples of the present disclosure allow operator-preferred antennas to be used if desired including multi-band antennas, and in a number of cases avoid replacing any antennas at all, depending on the existing antenna installation. For instance, examples of the present disclosure include base station sites having two or more horizontally disposed antenna positions per sector, which is typical of the majority of base station sites, and especially in North America. Multiple antenna positions are used for example to support multiple spectrum bands, multiple-in/multiple-out (MIMO) antenna systems including space diversity, and so forth.

In accordance with the present disclosure, in one embodiment a base station port carrying a transmission signal normally intended for connection to a single antenna is instead connected to an RF splitting apparatus for connection to at least two antennas which are separated horizontally by more than a wavelength, and which have the same boresight bearing. Examples of the present disclosure intentionally create an inferometric radiation pattern in the azimuth plane comprising a number of grating lobes and nulls across the sector. Furthermore, in various embodiments the separation distance is selected to be an odd number of half wavelengths. Notably, this ensures that substantial radiation pattern inferometric nulls are created at +/−90 degrees relative to the antenna azimuth boresight, and hence significantly improves the front-to-side (FTS) ratio, which in turn improves inter-sector interference. In addition, a system that spaces and co-phases two spatially diverse antennas in accordance with the present disclosure can achieve sharper roll of edges, maintain a wider azimuth angle (e.g., greater than 15 dB carrier-to-interference (C/I) ratio) and provide improved data rates (e.g., approximately 50 percent throughput gain).

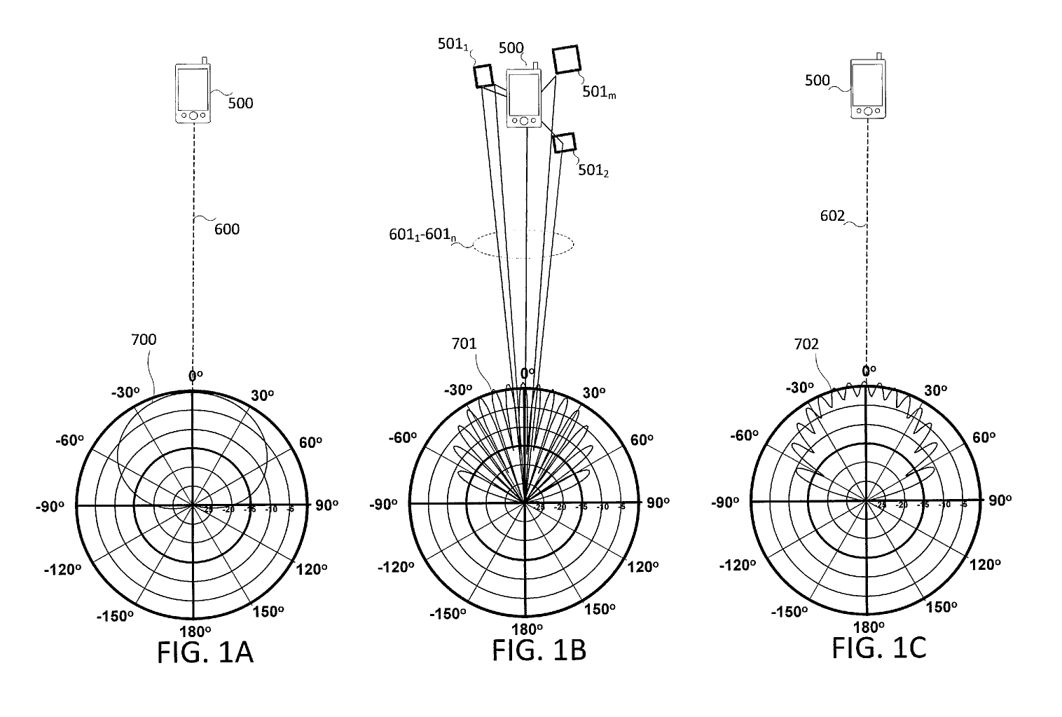

Examples of the present disclosure utilize the fact that the mobile radio channel between base station and mobile terminals is a multi-path channel and hence dispersive due to scattering. The multi-path dispersion means that RF energy between base station and terminal subtends a range of angles in the azimuth plane; angular dispersion or angular spread typically ranges from a few degrees in low dispersion channels to many 10's of degrees in highly dispersive channels. For example, it has been observed that typical macro cellular radio channels might exhibit angular dispersion of between 5-15 degrees. The effect of this dispersion is illustrated in the examples of FIGS. 1A-1C, described in greater detail below.

In one example, the present disclosure comprises an arrangement of two or more antennas at a base station site which are vertically disposed (e.g., at least two per sector). In such case, an inferometric radiation pattern in the elevation plane would be generated. The angular spread in the elevation plane, due to the multi-path radio channel, may vary as a function of elevation angle, with greater angular spread being observed when the mobile terminal is close to the site and hence at large elevation angles down from the horizon plane. At low elevation angles close to the horizon, when the mobile is farther away, there would be much smaller angular spread in elevation. For instance, the scattering volume can be viewed as a constant volume around the mobile terminal (e.g. houses, streets, buildings, etc.), which would contribute to multi-path subtending a range of angles in elevation, which diminishes as the mobile terminal is farther away from the base station site. Vertically disposed antennas according to the present disclosure may be used to increase the upper portion of the mainbeam roll-off rate which can be exploited to minimize energy directed toward the horizon and hence inter-site interference.

FIG. 1A depicts a mobile terminal (500) which is at approximately azimuth boresight to a conventional base station sector where the antenna azimuth radiation or gain pattern is described in the polar plot (700). A communications link (either uplink or downlink or both) is denoted by the dotted line between base station antenna and mobile terminal (600).

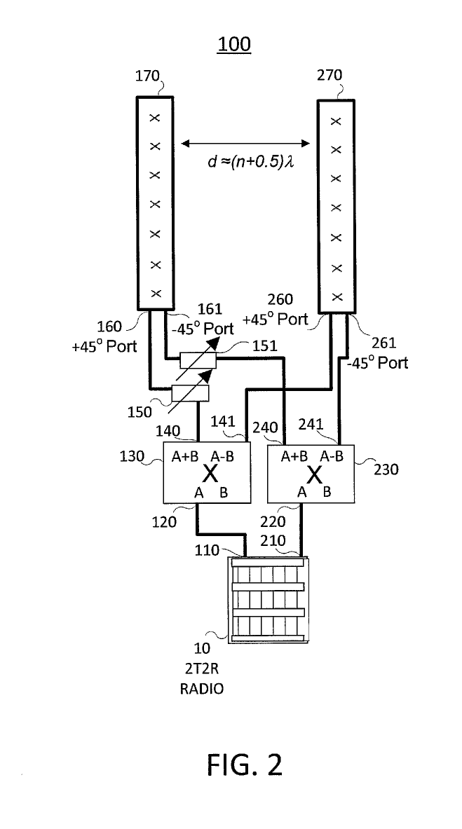

FIG. 1B depicts the same mobile terminal (500) communicating with a base station antenna arrangement according to the present disclosure (e.g., the arrangement of FIG. 2) which exhibits an azimuthal radiation pattern which has an inferometric pattern comprising a number of grating lobes and nulls (701). A number of dominant propagation paths (601₁ to 601ₙ), or multi-path propagation, exists by virtue of scatterers (501₁ to 501ₘ) in the radio channel, which are typically close to, and surround the mobile terminal (500) in a macro cellular radio environment. The multi-path propagation will subtend a range of angles in azimuth and hence exhibit angular dispersion or angular spread. If the angular spread of the radio channel is commensurate or greater than the grating lobe to grating lobe (or grating null to null) angular width, then null-fill occurs (in other words, nulls of the inferometric radiation pattern are reduced across a range of angles as compared to the same communication scheme without radio channel dispersion and scattering) and, as far as the mobile terminal (500) is concerned, the base station antenna pattern appears essentially unchanged, for example at 65 degrees beamwidth.

FIG. 1C illustrates the base station azimuth radiation gain pattern with respect to the mobile terminal (500) to base station link (602) when in a dispersive radio channel. The base station antenna gain pattern (702) appears largely unchanged and not dissimilar to the antenna gain pattern (700) as depicted in FIG. 1A. For example, there is some gain ripple exhibited across its aperture. However, the inferometric nulls created at +/−90 degrees relative to boresight are much wider than the inferometric nulls created within the +/−60 to 65 degree sector aperture/beamwidth, due to the fact that the lobe-to-lobe angular distance is a function of the cosine of the azimuth angle. Ideally the nulls at +/−90 degrees are wider than the angular spread of the channel to ensure good inter-sector interference reduction. Nevertheless, even if the angular spread is large, the existence of the nulls at +/−90 degree will serve to improve inter-sector interference over the case of the single antenna. In addition, the gain pattern (702) illustrates null-fill in the +/−60 degree sector as compared to the gain pattern (701) of FIG. 1B.

To further aid in understanding the present disclosure, a first example system (100) is illustrated in FIG. 2. As depicted in FIG. 2, two dual cross-polarized antennas (170, 270) with approximately 65 degrees azimuth beamwidth are deployed and designed in accordance with the present disclosure. For instance, the example of FIG. 2 may provide an LTE Frequency Division Duplex (FDD) service, e.g., at the 700 MHz band. The LTE base station radio (10) (e.g., a “radio base station”) in this case is a conventional dual-duplexed radio unit with two transmit/receive (Tx/Rx) duplexed ports (110, 210); termed a 2T2R radio. The first Tx/Rx signal (110) from the 2T2R radio (10) is split into two branches via connection to the in-phase port (120) of a first 180 degree hybrid coupler (130) providing in-phase branches at its ports (140, 141); similarly the second Tx/Rx signal (210) from the 2T2R radio (10) is connected to the in-phase port (220) of a second 180 degree hybrid coupler (230), providing in-phase branches at its ports (240, 241). As illustrated in FIG. 2, signals A and B at the ports of the 180 degree hybrid couplers (130, 230) are vector combined in-phase at the ports (140, 240) denoted as A+B, and vector combined out-of-phase at the ports (141, 241) denoted as A-B. However, it should be noted that signals are only connected as in-phase “A” signals at ports (120, 220) only. The out-of-phase ports (for signals “B”) are not used in this example. It should also be noted that although the example of FIG. 2 illustrates 180 degree hybrid couplers (130, 230), in other further and different embodiments RF splitters, 90 degree hybrid couplers and the like may alternatively or additionally be employed. The first signal pair of branches (140, 141) are connected to the +45 degree polarised ports (160, 260) of the two cross-polarised antennas (170, 270), and the second pair of branches (141, 241) are connected to the −45 degree polarised ports (161, 261) of the two cross-polarised antennas (170, 270).

In accordance with the present disclosure, the separation distance, d, of the antennas should nominally be an odd integer number of half wavelengths apart (e.g., d≈(n+0.5) A) such that the resulting Tx signal radiation pattern grating lobe-to-lobe distance across the 65 degree boresight beamwidth is less than the angular spread of the radio channel, and strong nulls are created at the +90 degree and −90 degree bearings relative to the boresight. For example, with a narrower angular spread of the radio channel, a larger value of d may be desired to create shorter lobe-to-lobe distances. Conversely, a greater angular spread of the radio channel may allow larger lobe-to-lobe distances to be accommodated, thus allowing the use of smaller values of d. A distance, d, different to an odd number of half wavelengths may also be chosen in order to optimise C/I performance across the sector aperture, which might be necessary depending on the specific antenna azimuth pattern. Variable RF phase shifters (150, 151) can be optionally inserted prior to the connection ports of one of the dual-polarized antennas (e.g., shown in FIG. 2 as being connected to the connection ports (160, 161) of dual-polarised antenna (170)) to adjust relative branch phasing to compensate for any phase variations introduced due to cabling length differences in each branch, or to compensate for phase if 90 degree hybrid couplers were used as the RF splitting means, and hence to optimise the Tx radiation pattern for minimum inter-sector interference. Alternatively, the phase shifters (150, 151) can be used to vary inter-sector overlap in the case greater sector overlap is desired, where adding a 180 degree phase delay using these phase shifters would create side-lobes rather than nulls at +/−90 degree azimuth angles.

The example of FIG. 2 optimises the inter-sector interference for the Tx signal since cellular data networks are generally downlink interference limited. However, with FDD systems, the Rx signals will be operating at a different range of frequencies in the spectrum band and needs also to be considered. For example, the antenna separation distance, d, might be set according to the mid frequency between Tx and Rx frequencies, if such frequencies are relatively close to one another. Another example includes calculating, selecting and/or utilizing a separation distance, d, which satisfies the condition that an odd number of half wavelengths are met for both Tx and Rx frequencies where there might be a larger duplex distance between Tx and Rx frequencies. It should be noted that in one embodiment, the example of FIG. 2 may further include all-pass filters on the connections to one of the dual-polarised antennas such that the delay/phase characteristics introduce more or less phase delay to Tx frequencies than Rx frequencies. In another embodiment, the hybrid couplers (130, 230) are removed and instead include RF components which would un-duplex the Tx/Rx lines from the 2T2R radio (10) into two component pairs of Tx and Rx lines, and apply splitting and phase shifting independently, before re-duplexing Tx and Rx signals. In still another embodiment, the RF splitting is performed at baseband, e.g., prior to power amplification in the base station radio equipment.

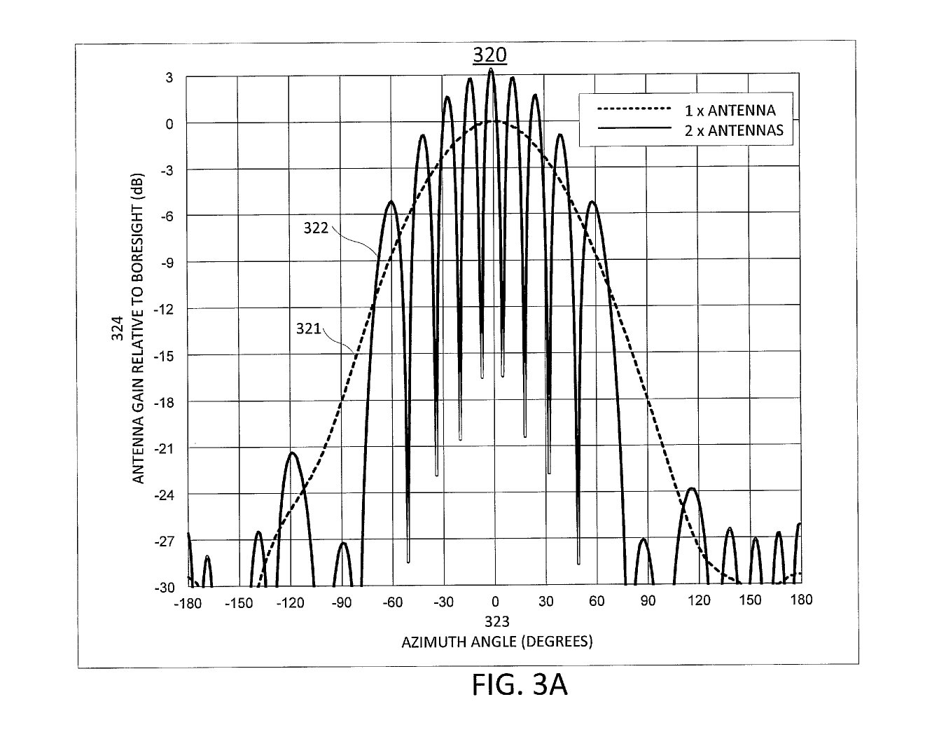

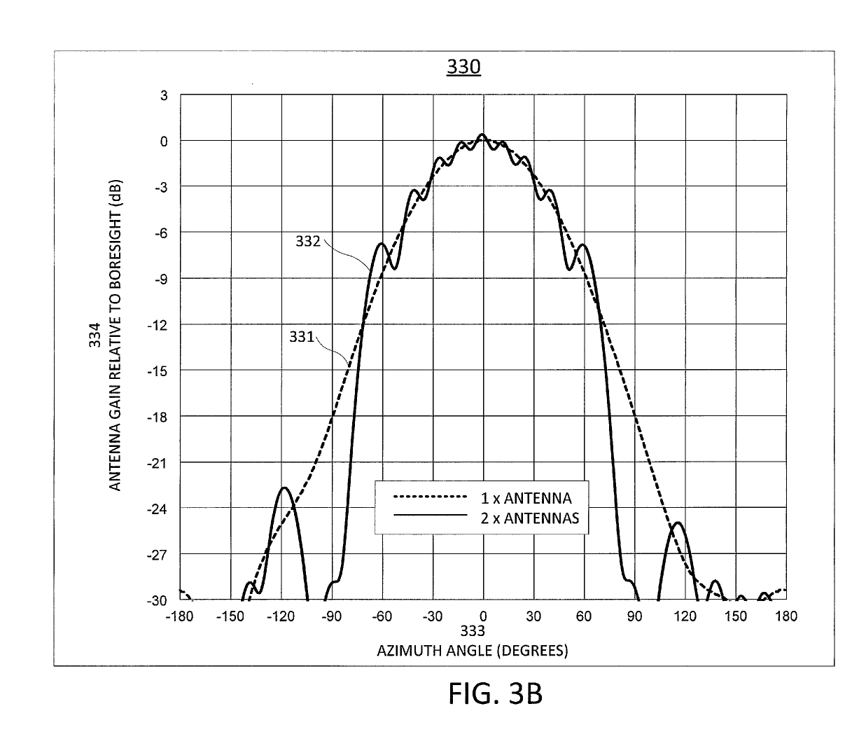

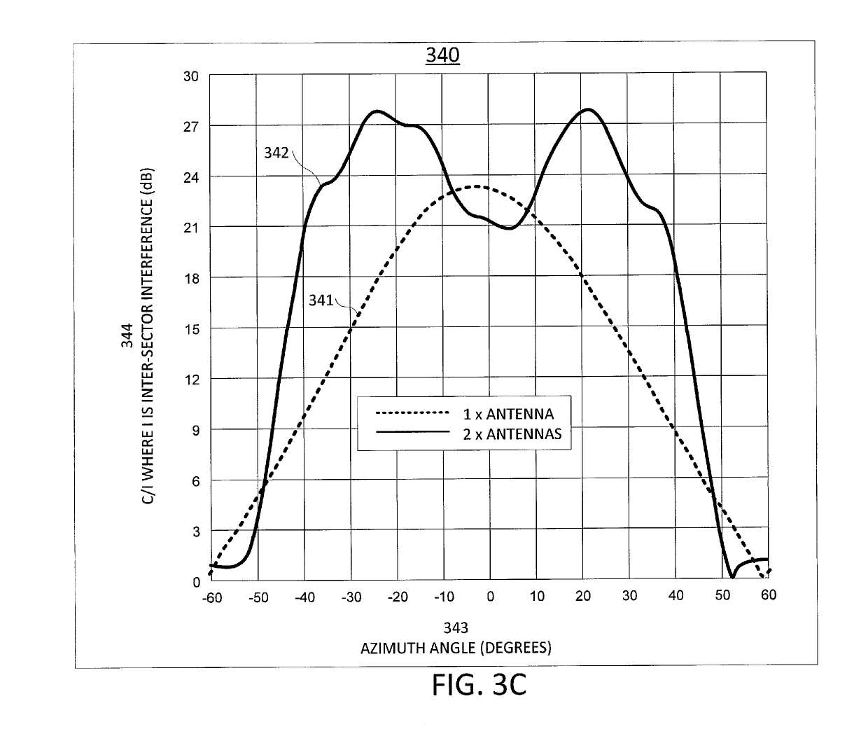

FIGS. 3A-3C illustrate the desired results from the example of FIG. 2. FIG. 3A illustrates a graph (320) of an antenna radiation pattern and resulting inferometric pattern using 2 antennas spaced 4.5λ apart, with no channel dispersion. A first axis (323) represents the azimuth angle in degrees. A second axis (324) represents the antenna gain relative to boresight in dB. In particular, in FIG. 3A the dotted line (321) depicts the gain or radiation pattern as a function of azimuth angle of a commercially available dual-cross-polarised 700 MHz band antenna of the +45 degree polarised array, 2 degree electrical tilt at 740 MHz, and which serves as a reference. The solid line (322) depicts the resulting inferometric radiation pattern as a function of azimuth angle resulting from the configuration described by the first example of FIG. 2, when two of the antennas are deployed and separated by 4.5λ, and the radio channel has no dispersion.

FIG. 3B depicts a graph (330) of an antenna radiation pattern and resulting inferometric pattern using 2 antennas spaced 4.5λ apart and with 10 degrees channel dispersion. The first axis (333) represents the azimuth angle in degrees. The second axis (334) represents the antenna gain relative to boresight in dB. In particular, graph (330) has the same reference (dotted line (331)) radiation pattern as in FIG. 3A, but with the solid line (332) representing the radiation pattern resulting from the first example of FIG. 2 when the radio channel has dispersion (a) of approximately 10 degrees. Angular dispersion (a) in this context, is defined as the range of angles where 90 percent of the multi-path energy is contained within. As can be clearly seen in FIG. 3B, despite some rippling in the azimuth pattern, the azimuth pattern roll-off rate is much enhanced relative to the single antenna, beyond the +/−60 degree sector bearings.

FIG. 3C depicts a graph (340) of C/I response (where “I” is Inter-Sector Interference (ISI)) using 2 antennas spaced 4.5λ apart and with 10 degrees channel dispersion. The first axis (343) represents the azimuth angle in degrees. The second axis (344) represents the C/I in dB. In graph (340) the solid line (342) represents the resulting C/I response, as a function of azimuth angle when three sectors of a tri-sector site are deployed at 120 degree intervals with the antenna configuration described and depicted in connection with FIG. 2. The dotted line (341) in FIG. 3C illustrates the resulting C/I when using the conventional single antenna as a reference. FIG. 3C demonstrates a significant gain in C/I over a much wider range of azimuth bearings, which in turn will result in improved spectral efficiency.

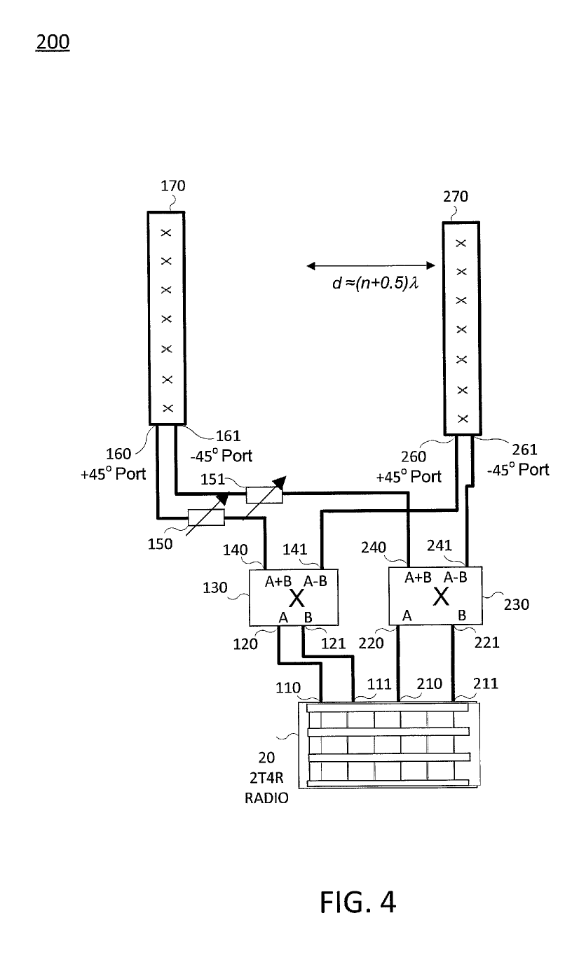

FIG. 4 illustrates a second example system (200) in accordance with the present disclosure. As illustrated in FIG. 4, two dual cross-polarized antennas with approximately 65 degree azimuth beamwidth (170, 270) are deployed and designed in accordance with the present disclosure. For instance, the example of FIG. 4 may provide an LTE FDD service, e.g., at the 700 MHz band. The LTE base station radio (20) (e.g., a “radio base station”) in this case is a “2T4R” radio with two Tx/Rx duplexed ports (110, 210) and two Rx only ports (111, 211). The first Tx/Rx signal (110) from the 2T4R radio (20) is split into two in-phase branches, or component signals “A” via connection to the in-phase port (120) of a first 180 degree hybrid coupler (130) providing in-phase branches; similarly the second Tx/Rx signal (210) from the 2T4R radio (20) is connected to the in-phase port (220) of a second 180 degree hybrid coupler (230), providing in-phase branches, or component signals “A” at its ports (240, 241). It should be noted that although the example of FIG. 2 illustrates 180 degree hybrid couplers (130, 230), in other, further and different embodiments RF splitters, 90 degree hybrid couplers and the like may alternatively or additionally be employed. The first signal pair of branches (140, 141) are connected to the +45 degree polarised ports (160, 261) of the two cross-polarised antennas (170, 270), and the second pair of branches (141, 241) are connected to the −45 degree polarised ports of the two cross-polarised antennas (170, 270). The first Rx only signal from the 2T4R radio (111) is connected to the second (out-of-phase) port (121) of the first 180 degree hybrid coupler (130), which for a Rx only signal is the out-of-phase vector sum of the component signals denoted by “B” and “−B” at its ports (140, 141). Similarly, the second Rx only signal from the 2T4R radio (211) is connected to the second (out-of-phase) port (221) of the second 180 degree hybrid coupler (230)), which for a Rx only signal is the out-of-phase vector sum of the component signals denoted by “B” and “−B” at its ports (240, 241). Thus, ports (140, 240) provide in-phase, or A+B component signals, while the ports (141, 241) provide out-of-phase, or A-B component signals.

In accordance with the present disclosure, the separation distance, d, of the antennas should nominally be an odd integer number of half wavelengths apart (e.g., d≈(n+0.5) A) such that the resulting Tx signal radiation pattern grating lobe-to-lobe distance across the 65 degree boresight beamwidth is less than the angular spread of the radio channel, and strong nulls are created at the +90 degree and −90 degree bearings relative to boresight. For example, with a narrower angular spread of the radio channel, a larger value of d may be desired to create shorter lobe-to-lobe distances. Conversely, a greater angular spread of the radio channel may allow larger lobe-to-lobe distances to be accommodated, thus allowing the use of smaller values of d. A distance, d, different to an odd number of half wavelengths may also be chosen in order to optimise C/I performance across the sector aperture, which might be necessary depending on specific antenna azimuth pattern. Variable RF phase shifters (150, 151) can be optionally inserted prior to the connection ports of one of the dual-polarized antennas (shown in FIG. 4 as being connected to connection ports (160, 161) of dual-polarised antenna (170)) to adjust relative branch phasing to compensate for any phase variations introduced due to cabling length differences in each branch, or to compensate for phase if 90 degree hybrid couplers were used as the RF splitting means, and hence to optimise the Tx radiation pattern for minimum inter-sector interference. Alternatively, the phase shifters (150, 151) can be used to vary inter-sector overlap in the case greater sector overlap is desired, where adding a 180 degree phase delay using the phase shifters would create side-lobes rather than nulls at +/−90 degree azimuth angles.

A 2T4R radio (20) such as that shown in FIG. 4 would normally require connection to two dual-polarised antenna arrays (i.e. 4x antenna ports), and therefore the second example system (200) (e.g., as illustrated in FIG. 4) allows improved inter-sector interference without adding any additional antennas or using any additional antenna positions. It should be noted that the 2T4R radio (20) employs 4-branch Rx combining at baseband such as Maximal Ratio Combining (MRC) or Interference Rejection Combining (IRC). As such, all Rx signals will be vector combined in an optimal manner at baseband and hence it is not be necessary to have to engineer separation distances to cater for Rx frequencies, as was discussed in connection with the example system (100) of FIG. 2. It should be noted that in various embodiments, the example system (200) of FIG. 4 may be modified in the same or similar manner as described above in connection with the example system (100) of FIG. 2, e.g., using all-pass filters on the connections to one of the dual-polarised antennas such that the delay/phase characteristics introduce more or less phase delay to Tx frequencies than Rx frequencies, replacing the hybrid couplers with RF components, and so forth.

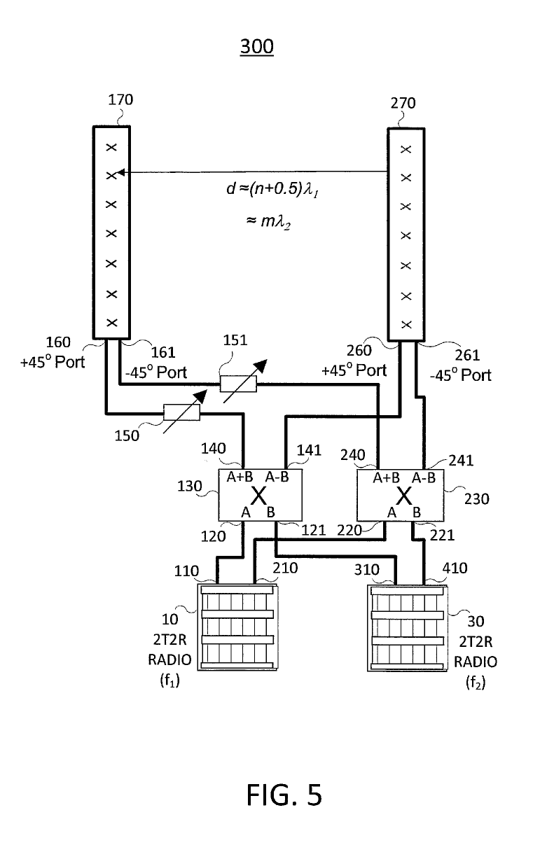

FIG. 5 illustrates a third example system (300) according to the present disclosure. As illustrated in FIG. 5, two dual cross-polarized antennas with approximately 65 degree azimuth beamwidth (170, 270) are deployed and designed in accordance with the present disclosure. For instance, the example of FIG. 5 may provide an LTE FDD service, e.g., at the 700 MHz band (f₁) and a HSPA FDD service, e.g., at the 850 MHz band (f₂). The LTE and HSPA base station radios (10, 30) (e.g., “radio base stations”) are each 2T2R radios, each with two Tx/Rx duplexed ports. The dual-polarised antennas (170, 270) have sufficient bandwidth to support 700 MHz and 850 MHz spectrum bands. The first Tx/Rx signal (110) from the LTE 2T2R radio (10) is split into two branches via connection to the in-phase port (120) of a first 180 degree hybrid coupler (130) providing two in-phase branches, or component signals “A” at its ports (140, 141); similarly the second Tx/Rx signal (210) from the LTE 2T2R Radio (10) is connected to the in-phase port (220) of a second 180 degree hybrid coupler (230), providing in-phase branches, or component signals “A” at its ports (240, 241). It should be noted that although the example of FIG. 5 illustrates 180 degree hybrid couplers (130, 230), in other, further and different embodiments RF splitters, 90 degree hybrid couplers and the like may alternatively or additionally be employed. The first signal pair of branches (140, 141) are connected to the +45 degree polarised ports (160, 260) of the two cross-polarised antennas (170, 270), and the second pair of branches (141, 241) are connected to the −45 degree polarised ports (161, 261) of the two cross-polarised antennas (170, 270). The first Tx/Rx signal (310) from the HSPA 2T2R radio (30) is connected to the second (out-of-phase) port (121) of the first 180 degree hybrid coupler (130), which creates out-of-phase component signals denoted by “B” and “−B” at its ports (140, 141), respectively. Similarly, the second Tx/Rx signal from the HSPA 2T2R radio (30) is connected to the second (out-of-phase) port (221) of the second 180 degree hybrid coupler (230), which also creates out-of-phase component signals denoted by “B” and “−B” at its ports (240, 241). Thus, ports (140, 240) provide in-phase, or A+B component signals, while the ports (141, 241) provide out-of-phase, or A−B component signals.

In accordance with the present disclosure, the separation distance, d, of the antennas should nominally be an odd integer number of half wavelengths apart for the 700 MHz LTE service (e.g., d≈(n+0.5) λ₁) such that the resulting Tx signal radiation pattern grating lobe-to-lobe distance across the 65 degree boresight beamwidth is less than the angular spread of the radio channel, and strong nulls are created at the +90 degree and −90 degree bearings relative to boresight. Additionally, if minimum inter-sector interference is also desired for the HSPA service then a distance, d, should be selected which is approximately an integer number of wavelengths for the Tx signal at 850 MHz band (e.g., d≈m λ₂). In particular, an integer number of wavelengths (rather than an odd number of half wavelengths) is preferred because the 850 MHz band signals are split via the second (out-of-phase) ports of the 180 degree hybrid couplers and thus the resulting 850 MHz split signals are 180 degrees out of phase. For example, with a narrower angular spread of the radio channel, a larger value of d may be desired to create shorter lobe-to-lobe distances. Conversely, a greater angular spread of the radio channel may allow larger lobe-to-lobe distances to be accommodated, thus allowing the use of smaller values of d. Variable RF phase shifters (150, 151) can be optionally inserted into the antenna signal paths (shown in FIG. 5 as being connected to dual-polarised antenna (170)) to adjust phase to optimise the Tx radiation pattern for minimum inter-sector interference, or alternatively to provide variation in the sector overlap, if desired.

Two 2T2R radios (10, 30) such as that shown in FIG. 5 would normally require connection to two dual-polarised antenna arrays (i.e. 4x antenna ports). Therefore the third example of the present disclosure (e.g., as shown in FIG. 5) allows improved inter-sector interference without adding any additional antennas or using any additional antenna positions. A number of other configurations and variations to the example of FIG. 5 are also possible to support two or more spectrum bands onto wideband antennas. These include the use of 90 degree hybrid couplers, duplexing and diplexing combining filters, for example, to perform the RF splitting and combining, and so forth.

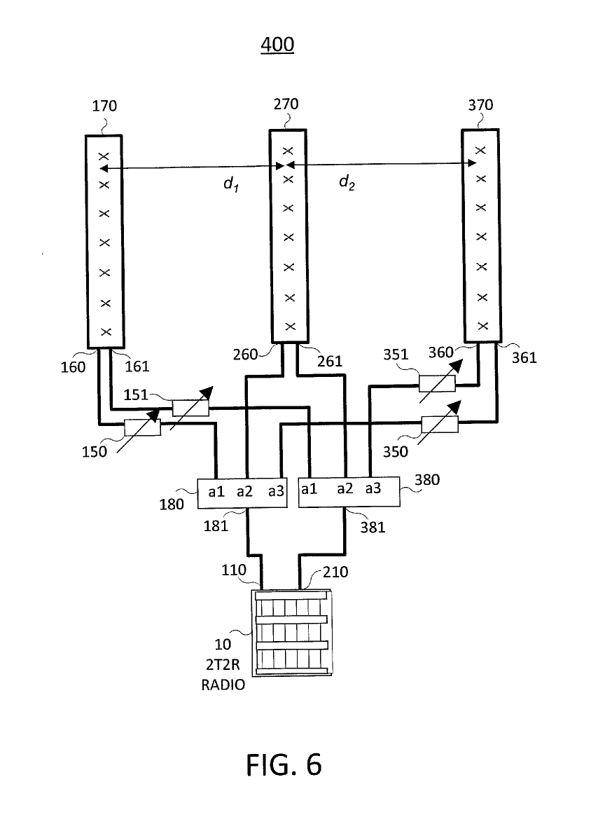

FIG. 6 illustrates a fourth example system (400) in accordance with the present disclosure. As depicted in FIG. 6, three dual cross-polarized antennas with approximately 65 degree azimuth beamwidth (170, 270, 370) are deployed and designed in accordance with the present disclosure. For instance, the example of FIG. 6 may provide an LTE Frequency Division Duplex (FDD) service, e.g., at the 700 MHz band. The LTE base station radio in this example is a conventional 2T2R dual-duplexed radio unit (10) (e.g., a radio base station”) with two Tx/Rx duplexed ports (110, 210). The first Tx/Rx signal (110) from the 2T2R radio (10) is split into three component signals via a first RF splitter (180) with in-phase branches; similarly the second Tx/Rx signal (210) from the 2T2R radio (10) is split into three in-phase component signals via a second RF splitter (380), thus forming two groups of three co-phased component signal branches. The RF splitters (180, 380) can have unequal splitting ratios, as denoted by a₁, a₂, a₃ on each RF splitter. The first group of signals are connected to the +45 degree polarised ports (160, 260, 360) of the three cross-polarised antennas (170, 270, 370), and the second group of signals are connected to the −45 degree polarised ports (161, 261, 361) of the three cross-polarised antennas (170, 270, 370). Variable RF phase shifters (150, 151) can be optionally inserted prior to the connection ports (160, 161) of the first dual-polarized antenna (170) and variable RF phase shifters (350, 351) can be optionally inserted prior to the connection ports (360, 361) of the third dual-polarized antenna (370), to adjust relative signal branch phasing to compensate for any phase variations introduced due to cabling length differences in each branch. The split ratios of the RF splitters (180, 380), the separation distances between the first (170) and second (270) cross-polarised antenna (d₁), and the second (270) and third (370) cross-polarised antenna (d₂), and optional phase shifters (150, 151, 350, 351) are all variable such that the resulting Tx and/or Rx signal radiation pattern grating lobe-to-lobe distance across the base station+/−60 degree sector is less than the angular spread of the radio channel, and inter-sector interference can be minimised or adjusted accordingly. For example, with a narrower angular spread of the radio channel, a larger value of d may be desired to create shorter lobe-to-lobe distances. Conversely, a greater angular spread of the radio channel may allow larger lobe-to-lobe distances to be accommodated, thus allowing the use of smaller values of d. The use of three spatially separated antenna positions and dispersive radio channel can result in very low Sector Power Ratios (SPR's) and minimal Inter-Sector Interference (ISI) and provides more design freedoms.

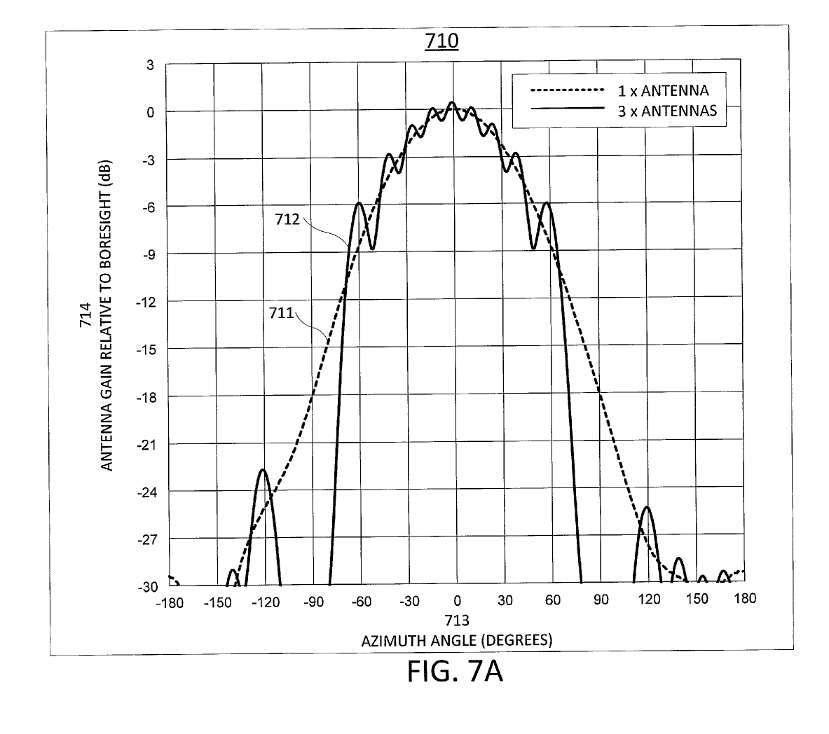

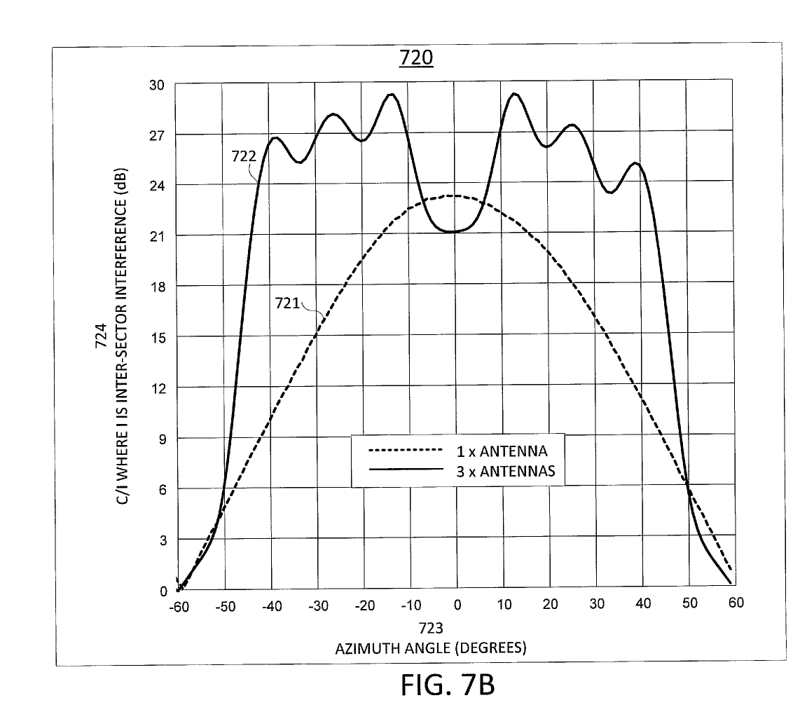

FIGS. 7A and 7B illustrate the desired result from the example of FIG. 6. FIG. 7A illustrates a graph (710) of an antenna radiation pattern and resulting inferometric pattern using 3 antennas spaced 4.66λ apart and with 10 degrees channel dispersion. The first axis (713) represents the azimuth angle in degrees. The second axis (714) represents the antenna gain relative to boresight in dB. In particular, in FIG. 7A the dotted line (711) depicts the gain or radiation pattern as a function of azimuth angle of a commercially available dual-cross-polarised 700 MHz band antenna of the +45 degree polarised array, 2 degree electrical tilt at 740 MHz, and which serves as a reference. The solid line (712) in FIG. 7A depicts the resulting radiation pattern as a function of azimuth angle resulting from the configuration described by the fourth example (e.g., the system (400) of FIG. 6) when the 1^{st} and 2^{nd}, and 2′^{d} and 3^{rd} antennas, (i.e. d₁ and d₂) are deployed and separated by 4.66λ, and the radio channel has an angular dispersion in the azimuth plane (a) of 10 degrees. The RF splitters (180, 380) have unequal splitting weights of a₁=0.2, a₂=0.6, a₃=0.2, and no additional phase delays are introduced by the RF phase shifters (150, 151, 350, 351). As can be clearly seen in the graph (720) of FIG. 7B, despite some residual rippling in the azimuth pattern, the azimuth pattern roll-off rate is much enhanced relative to the single antenna, beyond the +/−60 degree sector bearings. In particular, graph (720) illustrates C/I response (where “I” is Inter-Sector Interference (ISI)) using 3 antennas spaced 4.66λ apart and with 10 degrees channel dispersion. The first axis (723) represents the azimuth angle in degrees. The second axis (724) represents the C/I in dB. The solid line (722) in FIG. 7B illustrates the resulting C/I response (where I, is the inter-sector interference), as a function of azimuth angle when three sectors of a tri-sector site are deployed at 120 degree intervals with the antenna configuration described and depicted in connection with FIG. 6. The dotted line (721) in FIG. 7B illustrates the resulting C/I when using the conventional single antenna as a reference. FIG. 7B demonstrates a significant gain in C/I over a much wider range of azimuth bearings which in turn will result in improved spectral efficiency.

While the foregoing describes various examples in accordance with one or more aspects of the present disclosure, other and further example(s) in accordance with the one or more aspects of the present disclosure may be devised without departing from the scope thereof, which is determined by the claim(s) that follow and equivalents thereof.

What is claimed is:

1. An antenna system comprising:
at least one radio base station for transmitting at least one radio frequency signal via at least one transmission port;
at least one radio frequency splitting means for receiving the at least one radio frequency signal from the at least one radio base station and for splitting the at least one radio frequency signal into two component signals; and
at least two antennas separated by a distance greater than one wavelength and connected to the at least one radio frequency splitting means for transmitting the respective component signals such that an inferometric radiation gain pattern is created, wherein the at least one radio base station communicates with at least one mobile terminal via a dispersive multi-path radio channel where an angular spread of radio frequency energy between the at least two antennas and the at least one mobile terminal causes nulls of the inferometric radiation pattern across a range of angles to be reduced.

2. The antenna system of claim 1, wherein the at least one radio base station is further for receiving at least a second radio frequency signal.

3. The antenna system of claim 1, wherein the at least two antennas are arrays of a plurality of antenna elements, where the antenna elements are arranged to provide directivity and specific radiation patterns.

4. The antenna system of claim 1, wherein the at least two antennas are disposed in a horizontal geometric plane to create an inferometric gain pattern in an azimuthal radiation plane.

5. The antenna system of claim 1, wherein the at least one radio base station has at least two ports for transmission and wherein the at least two antennas comprise at least two dual-polarised antennas.

6. The antenna system of claim 1, wherein the at least two antennas comprise at least two dual-polarised antennas, wherein the at least one radio base station comprises two duplexed transmit/receive ports and two receive only ports, wherein the at least one radio frequency splitting means comprises two hybrid combiners where the two duplexed transmit/receive ports are connected to respective in-phase ports of the two hybrid combiners, and the two receive only ports are connected to respective out-of-phase ports of the two hybrid combiners.

7. The antenna system of claim 1, wherein the distance between the at least two antennas is an odd number of half wavelengths, wherein the distance is selected to create azimuth radiation pattern nulls in an azimuth plane of the at least two antennas, wherein the azimuth radiation pattern nulls include at least two nulls at plus and minus 90 degree bearings in the azimuth plane of the at least two antennas.

8. The antenna system of claim 1, wherein the distance between the antennas is a whole number of wavelengths, wherein the distance is selected to create azimuth radiation pattern lobes in an azimuth plane of the at least two antennas, wherein the azimuth radiation pattern lobes include at least two lobes at plus and minus 90 degree bearings in the azimuth plane of the at least two antennas.

9. The antenna system of claim 1, wherein the at least two antennas comprise at least two dual-polarised antennas, wherein the at least one radio base station comprises a first radio base station for operating in a first spectrum band and having two duplexed transmit/receive ports, and a second radio base station for operating in a second spectrum band and having two duplexed transmit/receive ports, wherein the at least one radio frequency splitting means comprises two hybrid combiners where the two duplexed transmit/receive ports of the first radio base station are connected to respective in-phase ports of the two hybrid combiners, and the two duplexed transmit/receive ports of the second radio base station are connected to respective out-of-phase ports of the two hybrid combiners.

10. The antenna system of claim 9, wherein the distance between the at least two antennas is an odd number of half wavelengths associated with the first spectrum band and also a whole number of wavelengths associated with the second spectrum band, wherein the distance is further selected to create azimuth radiation pattern nulls in a azimuth plane of the at least two antennas, wherein the azimuth radiation pattern nulls include at least two nulls at plus and minus 90 degree bearings in the azimuth plane of the at least two antennas and for both the first spectrum band and the second spectrum band.

11. The antenna system of claim 1, wherein the at least one radio base station has two ports for transmission, wherein the at least two antennas comprise three dual-polarised antennas, where a first port of the radio base station is connected to a first three-way radio frequency splitter to create a first group of three component signals, wherein a second port of the radio base station is connected to a second three-way radio frequency splitter to create a second group of three component signals, wherein a first component signal from the first group of three component signals and a first component signal from the second group of three component signals are connected to respective polarised ports of a first dual-polarised antenna of the three dual-polarised antennas, wherein a second component signal from the first group of three component signals and a second component signal from the second group of three component signals are connected to respective polarised ports of a second dual-polarised antenna of the three dual-polarised antennas, wherein a third component signal from the first group of three component signals and a third component signal from the second group of three component signals are connected to respective polarised ports of a third dual-polarised antenna of the three dual-polarised antennas.

12. The antenna system of claim 11, wherein a separation distance between the first dual-polarised antenna and the second dual-polarised antenna, a separation distance between the second dual-polarised antenna and the third dual-polarised antenna, split ratios of the first three-way radio frequency splitter and of the second three-way radio frequency splitter, and phase delays applied to the first component signal, the second component signal and the third component signal of the first group of three component signals and to the first component signal, the second component signal and the third component signal of the second group of three component signals are selected to create nulls in an azimuth plane of the three-dual polarised antennas, wherein the nulls in the azimuth plane of the three dual-polarised antennas include at least two nulls at plus and minus 90 degree bearings in the azimuth plane of the three dual-polarised antennas.

13. A method, comprising:
transmitting at least one radio frequency signal via at least one transmission port of at least one radio base station;
receiving the at least one radio frequency signal from the at least one radio base station via at least one radio frequency splitting means;
splitting the at least one radio frequency signal into two component signals via the at least one radio frequency splitting means; and
transmitting the respective component signals via at least two antennas separated by a distance greater than one wavelength and connected to the at least one radio frequency splitting means, such that an inferometric radiation gain pattern is created, wherein the at least one radio base station communicates with at least one mobile terminal via a dispersive multi-path radio channel where an angular spread of radio frequency energy between the at least two antennas and the at least one mobile terminal causes nulls of the inferometric radiation pattern across a range of angles to be reduced.

14. The method of claim 13, further comprising:
receiving at least a second radio frequency signal via the at least two antennas.

15. The method of claim 13, wherein the at least two antennas are arrays of a plurality of antenna elements, where the antenna elements are arranged to provide directivity and specific radiation patterns.

16. The method of claim 13, wherein the at least two antennas are disposed in a horizontal geometric plane to create an inferometric gain pattern in an azimuthal radiation plane.

17. The method of claim 13, wherein the at least one radio base station has at least two ports for transmission and wherein the at least two antennas comprise at least two dual-polarised antennas.

18. The method of claim 13, wherein the at least two antennas comprise at least two dual-polarised antennas, wherein the at least one radio base station comprises two duplexed transmit/receive ports and two receive only ports, wherein the at least one radio frequency splitting means comprises two hybrid combiners where the two duplexed transmit/receive ports are connected to respective in-phase ports of the two hybrid combiners, and the two receive only ports are connected to respective out-of-phase ports of the two hybrid combiners.

19. The method of claim 13, wherein the distance between the at least two antennas is an odd number of half wavelengths, wherein the distance is selected to create azimuth radiation pattern nulls in an azimuth plane of the at least two antennas, wherein the azimuth radiation pattern nulls include at least two nulls at plus and minus 90 degree bearings in the azimuth plane of the at least two antennas.

20. The method of claim 13, wherein the distance between the antennas is a whole number of wavelengths, wherein the distance is selected to create azimuth radiation pattern lobes in an azimuth plane of the at least two antennas, wherein the azimuth radiation pattern lobes include at least two lobes at plus and minus 90 degree bearings in the azimuth plane of the at least two antennas.

21. The method of claim 13, wherein the at least two antennas comprise at least two dual-polarised antennas, wherein the at least one radio base station comprises a first radio base station for operating in a first spectrum band and having two duplexed transmit/receive ports, and a second radio base station for operating in a second spectrum band and having two duplexed transmit/receive ports, wherein the at least one radio frequency splitting means comprises two hybrid combiners where the two duplexed transmit/receive ports of the first radio base station are connected to respective in-phase ports of the two hybrid combiners, and the two duplexed transmit/receive ports of the second radio base station are connected to respective out-of-phase ports of the two hybrid combiners.

22. The method of claim 13, wherein the distance between the at least two antennas is an odd number of half wavelengths associated with the first spectrum band and also a whole number of wavelengths associated with the second spectrum band, wherein the distance is further selected to create azimuth radiation pattern nulls in a azimuth plane of the at least two antennas, wherein the azimuth radiation pattern nulls include at least two nulls at plus and minus 90 degree bearings in the azimuth plane of the at least two antennas and for both the first spectrum band and the second spectrum band.

23. The method of claim 13, wherein the at least one radio base station has two ports for transmission, wherein the at least two antennas comprise three dual-polarised antennas, where a first port of the radio base station is connected to a first three-way radio frequency splitter to create a first group of three component signals, wherein a second port of the radio base station is connected to a second three-way radio frequency splitter to create a second group of three component signals, wherein a first component signal from the first group of three component signals and a first component signal from the second group of three component signals are connected to respective polarised ports of a first dual-polarised antenna of the three dual-polarised antennas, wherein a second component signal from the first group of three component signals and a second component signal from the second group of three component signals are connected to respective polarised ports of a second dual-polarised antenna of the three dual-polarised antennas, wherein a third component signal from the first group of three component signals and a third component signal from the second group of three component signals are connected to respective polarised ports of a third dual-polarised antenna of the three dual-polarised antennas.

24. The method of claim 13, wherein a separation distance between the first dual-polarised antenna and the second dual-polarised antenna, a separation distance between the second dual-polarised antenna and the third dual-polarised antenna, split ratios of the first three-way radio frequency splitter and of the second three-way radio frequency splitter, and phase delays applied to the first component signal, the second component signal and the third component signal of the first group of three component signals and to the first component signal, the second component signal and the third component signal of the second group of three component signals are selected to create nulls in an azimuth plane of the three-dual polarised antennas, wherein the nulls in the azimuth plane of the three dual-polarised antennas include at least two nulls at plus and minus 90 degree bearings in the azimuth plane of the three dual-polarised antennas.
